(19) United States
(12) Patent Application Publication
(10) Pub. No.: US 2024/0345266 A1
(43) Pub. Date: Oct. 17, 2024

(54) Systems, Methods, and Apparatuses for Radiation Consequence Analysis

(71) Applicant: CONSTELLATION ENERGY GENERATION, LLC, Kennett Square, PA (US)

(72) Inventors: Shane R Gardner, Kennett Square, PA (US); David Knepper, Kennett Square, PA (US); Baris Sarikaya, Kennett Square, PA (US); John Massari, Kennett Square, PA (US)

(21) Appl. No.: 18/577,573

(22) PCT Filed: Jul. 11, 2022
(86) PCT No.: PCT/US2022/036667

§ 371 Date: Jan. 8, 2024

Related U.S. Application Data
(60) Provisional application No. 63/220,261, filed on Jul. 9, 2021.

(51) Int. Cl. G01T 1/02

(52) U.S. Cl. CPC G01T 1/02

(57) ABSTRACT

Methods, systems, and apparatuses for radiation consequence analysis are described herein. A computing device may receive a plurality of input parameters associated with a postulated release of radioactivity. The computing device may determine a plurality of randomly sampled values of the plurality of input parameters via a random sampling process. The computing device may determine an estimate of a radiation dose associated with a radiation release resulting from the postulated release of radioactivity. The computing device may determine a statistical uncertainty associated with the estimate of the radiation dose.

### CROSS-REFERENCE TO RELATED APPLICATIONS

This application claims the benefit of U.S. Provisional Application No. 63/220,261, filed Jul. 9, 2021, which is incorporated herein by reference in its entirety.

### BACKGROUND

Safety analysis for a nuclear power plant may be needed to consider postulated accidents that result in at-risk accidental releases of potentially harmful radiation. In the United States, the Nuclear Regulatory Commission (NRC) promulgates guidelines to regulate the safety and public health consequences of nuclear energy. The NRC may require a satisfactory safety analysis report that includes an evaluation of the requirements of 10 C.F.R. § 50.67. Such a safety analysis report mandates limits such that calculated radiological consequences relative to certain dose locations do not exceed total effective dose equivalent (TEDE) limits following a postulated release of radioactivity. Calculations are performed to estimate the radiological consequences, in terms of dose, to people and equipment to ensure the estimated radiation doses are within the prescribed limits. Analysis should demonstrate, with reasonable assurance, that these prescribed limits are complied with. Existing methodologies utilize conservative approaches to address lack of uncertainty quantification in the utilized approaches, methods, and/or inputs. This built-in conservatism in multiple areas often result in compounding effects in terms of inaccuracies and hence overly conservative results in the estimated radiological consequences.

For example, a conventional conservative method uses a bounding approach for determining input parameters and resolving uncertainties. By use of the conventional conservative method, multiple input parameters may all be determined conservatively in a deterministic process which may be amplified and become excessively large due to compounding usage in a dose calculation. However, the conservative deterministic input parameter selections may not always produce a conservative result because it may be impossible to know the conservative direction of an input and because the non-realistic inputs interact in unexpected ways. Furthermore, the amplified effects resulting from use of conservative models and inputs also mask an estimate of the true margin to the applicable regulatory limits in dose calculations used to determine the best mitigation strategy to mitigate consequences of accidental radiation releases. These excessively large effects may also be a burden on the system design and operation requirements of a system containing radioactive material. Additionally, the multiplicative effect resulting from the aggregation of the conservative selections of bounding input results may cause an estimated radiation dose reflecting conservative use of input parameters beyond what is necessary for the reasonable assurance standard under 10 C.F.R. § 50.67.

### SUMMARY

It is to be understood that both the following general description and the following detailed description are exemplary and explanatory only and are not restrictive, as claimed. Methods, systems, and apparatuses for radiation consequence analysis are described herein. A computational system or apparatus may perform a method for analyzing the consequences of a postulated accidental release of radioactivity from a source of radioactive material, such as a nuclear energy plant. A method of the present disclosure may enable performing more accurate radiation dose calculations while accounting for uncertainties corresponding to the postulated accidental release of radioactivity. The postulated accidental release of radioactivity may refer to the accidental release of fission products resulting from severe damage to nuclear reactor fuel, for example. As another example, the postulated accidental release of radioactivity may refer to the accidental release of fission products resulting from a Loss of Coolant Accident (LOCA) that may result in the damage to the core. The calculations may be used to facilitate mitigation and control of the consequences of a postulated event (e.g., damaged nuclear reactor fuel) resulting in the postulated accidental release of radioactivity. For example, the radiation dose calculations can be performed to estimate the radiological consequences, in terms of dose, to people and equipment in the vicinity of the postulated accidental release of radioactivity to ensure the estimated doses are within prescribed limits, such as limits according to 10 C.F.R. § 50.67. The radiation dose calculations may be used to determine the design and operation of safety features of the nuclear plant that mitigate the consequences of the accident. The calculations may be a deterministic evaluation processed by a computing device (e.g., a computer 601). The implementation of the computing device may be necessary in consideration of the vast number of calculations that may be required to accurately determine whether the estimated doses associated with an uncontained postulated accidental release of radioactivity are within the prescribed limits.

The present disclosure may rely on a best estimate random probabilistic sampling of input parameters, rather than the deterministic bounding selection of all input parameters. All input parameters may be randomly sampled within their applicable distributions, although it is possible to sample only a number of key input parameters (e.g., a subset of critical input parameters of the entire set of input parameters). In this way, the inputs of the analysis may be sampled by using realistic distributions, which enables more accurate margin assessment for a given postulated radiation event scenario. That is, the sampling may enable a realistic approach along with quantification of uncertainties to provide both true margin and conformance to limits from a postulated release of radioactivity. This approach also enables determination of a more accurate response and/or mitigation that can be employed to address a particular scenario. The statistical treatment of the results also provides a bounding approach to satisfy governmental regulatory requirements. Input parameters associated with the release characteristics from postulated damage to a nuclear reactor core in a nuclear power plant dose analysis may be associated with the release fraction, chemical, and timing.

The random sampling of input parameters from various probability distributions may be achieved via a Monte Carlo method or other suitable computational random sampling algorithms of probability density functions (PDFs), for example. Such random sampling addresses the compounding effects of excessive conservation in estimated radiation dose calculations as described herein. In addition, random sampling may also prevent non-conservative results created by conservative inputs interacting with each other. A statistical sampling technique derived from the characteristics that define each input parameter may be applied to each sampled input parameter. This sampling can be sampled from each range of values indicated by the associated PDF corresponding to each input parameter. The sampled input parameters may each be inputs of the radiation dose calculation such that the resulting radiation doses are combined statistically to generate a mean radiation dose result to reflect a realistic estimate with an associated calculated statistical uncertainty (e.g., determining the statistical uncertainty from statistically simulating the radiation dose consequences of damage to a nuclear reactor core) to demonstrate compliance with regulatory limits. In this way, a best estimate of the unknown true population parameter of the radiation dose calculation with associated uncertainty can be determined. The mean radiation dose result with statistical uncertainty may provide a reasonably conservative result for demonstrating compliance with the prescribed limits of 10 C.F.R. § 50.67, for example. The present disclosure advantageously may be used to design systems or apparatuses (e.g. computing systems) that improve the ability to mitigate and control the consequences of a postulated event. For example, the mitigation and control may be better optimized to provide flexibility in design requirements, design, and operation without being masked by compounding conservatism built into conventional methodologies.

Additional advantages will be set forth in part in the description which follows or may be learned by practice. The advantages will be realized and attained by means of the elements and combinations particularly pointed out in the appended claims.

### BRIEF DESCRIPTION OF THE DRAWINGS

The accompanying drawings, which are incorporated in and constitute a part of this specification, illustrate embodiments and together with the description, serve to explain the principles of the methods and systems:

FIG. 1 shows a flowchart of an example method;

FIG. 2 shows a flowchart of an example method:

FIG. 3 shows a graph of an example probability function:

FIG. 4 shows a graph of an example probability function:

FIG. 5 shows a flowchart of an example method; and

FIG. 6 shows a block diagram of an example computing device.

### DETAILED DESCRIPTION

Before the present methods and systems are described, it is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Described are components that may be used to perform the described methods and systems. These and other components are described herein, and it is understood that when combinations, subsets, interactions, groups, etc. of these components are described that while specific reference of each various individual and collective combinations and permutation of these may not be explicitly described, each is specifically contemplated and described herein, for all methods and systems. This applies to all aspects of this application including, but not limited to, steps in described methods. Thus, if there are a variety of additional steps that may be performed it is understood that each of these additional steps may be performed with any specific embodiment or combination of embodiments of the described methods.

The present methods and systems may be understood more readily by reference to the following detailed description and the examples included therein and to the figures and their previous and following description. As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium (e.g., a non-transitory computer-readable medium) having processor-executable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, flash memory internal or removable, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, may be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory or medium that may direct a computer or other programmable data processing apparatus to function in a particular manner, such that the instructions (e.g. processor-executable instructions) stored in the computer-readable memory produce an article of manufacture including processor-executable instructions for implementing the function specified in the flowchart block or blocks. The processor-executable instructions may also be loaded onto a computer or other programmable data processing apparatus to cause a series of operational steps to be performed on the computer or other programmable apparatus to produce a computer-implemented process such that the processor-executable instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, may be implemented by special purpose hardware-based computer systems that perform the specified functions or steps, or combinations of special purpose hardware and computer instructions.

Methods, systems, and apparatuses for radiation consequence analysis are described herein. Various industries that involve radioactive material are governed by safety design requirements (e.g., mandated by the NRC) to ensure safety of the public and functionality of important equipment in the event of a postulated (e.g., hypothetical or theoretical) release, either by airborne transfer or indirect transmission of radiation, of the radioactive material. In order to ensure compliance with the safety design requirements, an analysis is performed. The analysis includes a calculation of the radiation dose consequences of the postulated release. Rather than deterministically selecting the values of multiple input parameters for a radiation dosage estimation model, a method of the present disclosure advantageously may involve randomly sampling the values of the multiple input parameters. In consideration of the vast sampling that may randomly be completed to determine whether the radiation dose complies with safety design requirements of a jurisdiction (e.g., a country), a computing device (e.g., the computer 601) may be utilized to accurately sample the values of the multiple input parameters. The computing device may advantageously be utilized to determine whether the radiation dose complies with the safety design requirements of the jurisdiction due to the speed by which the sampling of the values of the multiple input parameters may be made. This described advantage is beneficial to mitigate risks of non-compliant postulated releases of radiation doses in a timely manner that otherwise may be quickly promulgated.

The sampled input parameters may be analyzed using a dose calculation computer program such as a RADionuclide Transport, Removal, and Dose (RADTRAD) model used to calculate estimated radiation doses at offsite locations (relative to the source of radioactive material). The outputs of the dose calculation model may be statistically combined to determine a best realistic estimate. Statistical uncertainty values may be added to the realistic estimate to obtain a reasonably bounding best estimate result with quantified uncertainty. The uncertainty values may be, for example, a 95%/95% uncertainty value indicative of the calculated dose value bounding the range of possible values with 95% probability and 95% confidence. By calculating the best realistic estimate of the radiation doses in this way, the present disclosure may improve the design and operation of systems and apparatuses to mitigate and control the consequences of a postulated accidental release event.

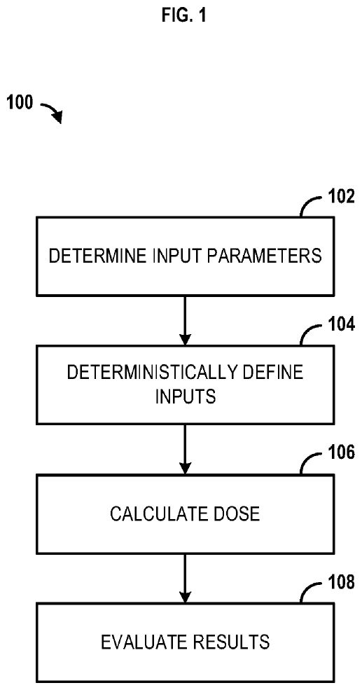

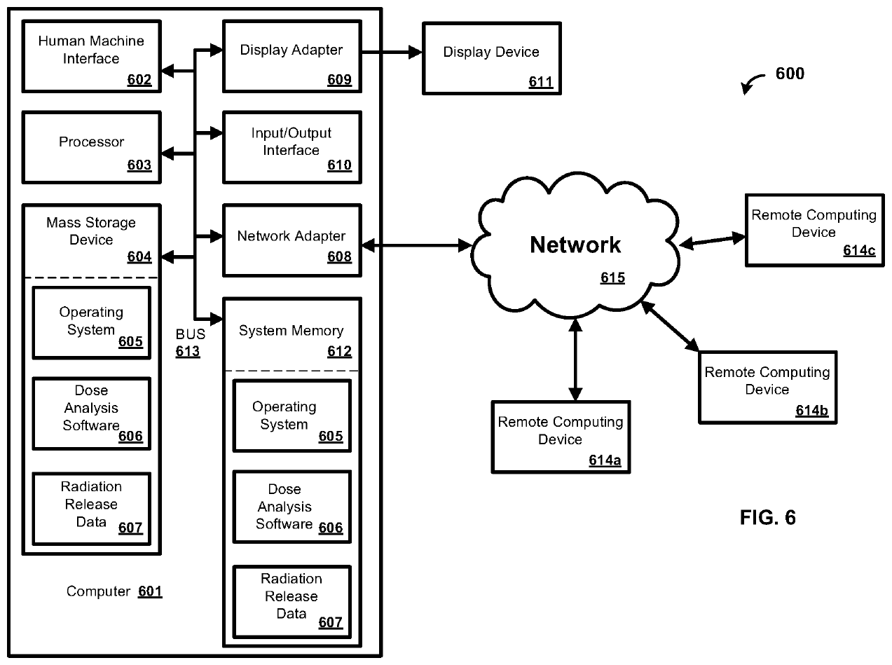

FIG. 1 shows a flowchart illustrating an example method 100 for radiation consequence analysis involving a calculation of dose consequences for a postulated (e.g., hypothetical or theoretical) accidental release of radiation. The dose consequences may be used to provide best estimate calculations of emergency core cooling system performance for nuclear reactor cores. The method 100 may be implemented using the environment shown in FIG. 6. For example, the method 100 may be implemented using a computing device such as the computing device 601. At step 102, the necessary input parameters to perform the analysis of radiation dose consequences may be derived. The input parameters may include, but are not be limited to, one or more of the following: release fraction and timing, fission product removal method, filter efficiency, ventilation flow rate, leak rate, nuclear reactor (e.g., boiling water reactor) building drawdown time, control room unfiltered in-leakage, radionuclide source term released from reactor core, radionuclide inventory as a function of burnup and initial enrichment, removal processes of radionuclide aerosols, removal processes of elemental iodine radionuclides, removal processes due to filters, system flow rates and leak rates, atmospheric dispersion, breathing rates (e.g, including control room breathing), and/or the like. Atmospheric dispersion may depend on weather conditions and may be measured based on meteorological data.

Low wind conditions may result in the accidental release of radiation staying around the postulated release site such as in the form of a cloud. The input parameters may be organized by the nature of the respective input parameter. For example, the input parameters may be organized by urgency. However, input parameters may not constitute the alternative source term (AST) officially. For example, various parameters may be based on statistical processes, equipment tolerance, technical specifications, and/or a combination thereof. The input parameters may be source terms of the consequences of a postulated loss of coolant accident (LOCA). For example, the input parameters may be used to analyze the consequences of LOCA that result in damage to the fuel rods and/or nuclear reactor core (e.g, a meltdown of the core) of a nuclear power plant. AST analysis may be used to provide reasonable assurance pursuant to 10 C.F.R. § 50.67. For example, another suitable set of input parameters may be aerosol removal rate relative to aerosol settling in main stream lines of the nuclear power plant. The aerosol removal rate can be used in sensitivity and uncertainty analysis to compute an effective aerosol settling velocity that is adequate for use with sprays according to 10 C.F.R. § 50.67.

The appropriate AST input parameters may be determined at step 102 for the desired analysis of radiation consequences of a postulated event. The AST input parameters may be primarily determined from characteristics associated with the source of the radioactive material, the systems that are designed to contain, process, transport and control any postulated release, the atmospheric conditions associated with an airborne release, and from the receptor of the dose. The receptor may refer to the characteristics of the people postulated to be exposed to the postulated release of radiation. Due to the existence of multiple input parameters that affect the radiation dose calculation, statistical uncertainty is involved in the dosage calculation. The multiple AST input parameters may each be modeled by a probability distribution, which may differ among one or more parameters.

For a given AST input parameter, a deterministic approach may be employed. That is, at step 104, the input parameters may be deterministically defined by, for example, the computing device 601. For example, the input parameters may be selected as a bounding input from the associated characteristics via a bounding selection from a range of values associated with the corresponding input parameter. Further, deterministic selection may be performed based on sensitivity analysis of the radiation dose result, such as analysis of how the value of a particular input parameter results in a higher radiation dose result for that particular input. This bounding input selection approach may be applied for all input parameters.

For example, a radiation dose calculation model may have ten input parameters selected based upon their relative importance—a probability distribution function (PDF) may be determined for more important inputs and less important inputs may be conservatively selected. Non-important inputs may be set to nominal values. Based on the respective PDF, one input parameter may be defined by having a possible set of values in the range of 0.8 to 1.2. In this example, the deterministic selection at step 104 involves evaluating the dose calculation model with the one input parameter being set at 1.2. The one input parameter value may be a statistically bounding atmospheric dispersion factor, for example. Selection of the 1.2 value may be a conservative bounding input selection that is indicative of a worst case scenario (e.g. the amount of radioactive release associated with a LOCA accident). That is, the deterministic selection at step 104 may assume bounding release of such radioactivity released from the damaged fuel rods. As such, the value of the input parameter is deterministically selected from the corresponding input PDF to bound the input PDF so that the dose result is conservatively large. For example, if the input parameter follows a normal distribution and is proportional to the amount of the dose, the value of the input parameter may be set as a value that is equal to the mean value plus two standard deviations. This mean plus two standard deviations value may bound the range of possible values with 95% probability and 95% confidence (i.e. 95/95 value) according to the statistical behavior of a normal distribution. As another example, the value of the input parameter may be a fixed value.

At step 106, the dose may be calculated. For example, the dose may be calculated by the computing device 601 using the dose calculation model and the deterministically selected input parameters. The plurality of deterministically selected input parameters may be input or entered into the dose calculation model. The calculation of the radiation dose may involve processing the input parameters through established numerical calculations in approved codes to determine radiation dose consequences at desired receptor locations. The established calculations may be based on factors such as nuclear plant specific geometry, initial conditions, boundary conditions, operating parameters, design parameters and the like. For example, the factors may include nuclear core design parameters, AST parameters, atmospheric dispersion factors, and the like. The receptors may comprise locations in space, people or sensitive equipment and have prescribed safety limits. The established numerical calculations may relate or mathematically quantify the relationship between various selected AST input variables and specific receptors throughout the postulated release site.

At step 108, the results may be evaluated. For example, the results may be evaluated by the computing device 601. For example, the results may be evaluated relative to the prescribed safety limits, such as internal safety limits or NRC specified safety limits. Acceptable results demonstrate, with reasonable assurance, that the design of the system adequately meets safety design requirements with substantial margin to the limits pursuant to 10 C.F.R. § 50.67. For example, the estimated value of the calculated dose may have a variability that is sufficiently small to comply with the safety limits.

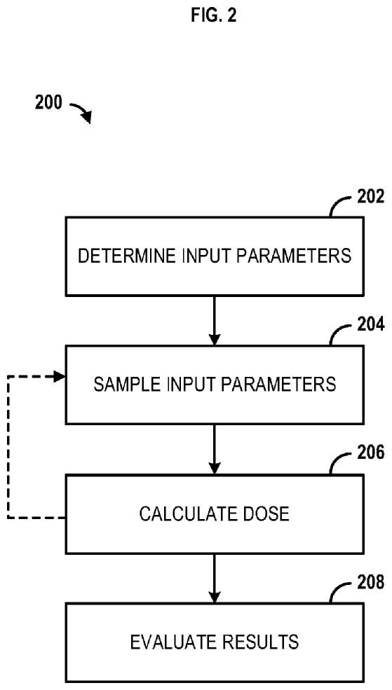

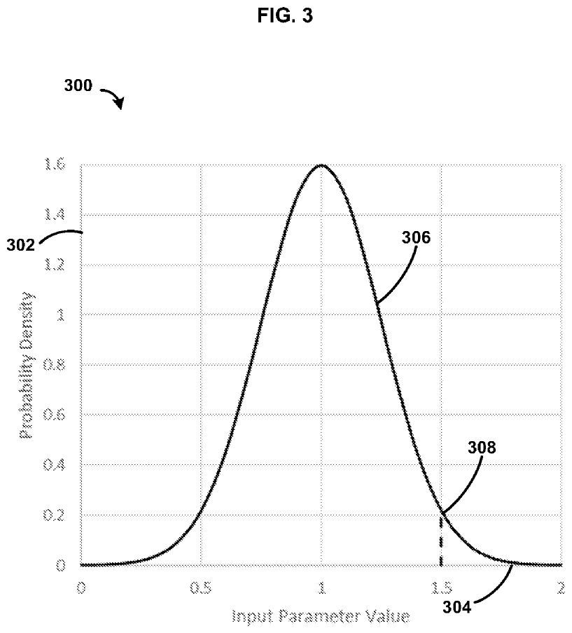

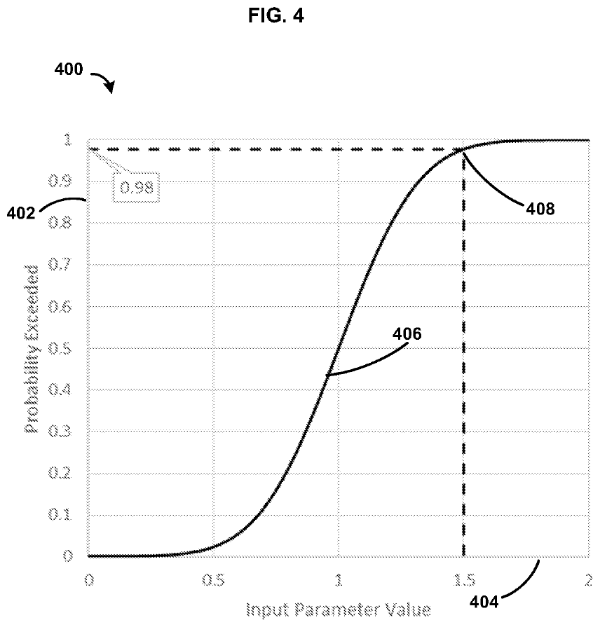

FIG. 2 shows a flowchart illustrating an example method 200 for radiation consequence analysis involving a calculation of radiation dose consequences for a postulated accidental release of radiation. The method 200 may be implemented using the environment shown in FIG. 6. For example, the method 200 may be implemented using a computing device such as the computing device 601. At step 202, the necessary input parameters to perform the analysis may be determined and defined. For example, the input parameters may be determined by the computing device 601. The definition of the parameters may be based on identifying respective PDFs or cumulative distribution functions (CDFs), such as the PDF and CDF depicted respectively in FIG. 3 and FIG. 4, that model the behavior of the respective input parameters. The PDFs and CDFs may be determined based on sensitivity analysis, tolerance range analysis, simulation and the like. In addition, PDFs may be determined by measurement, test and/or experimental data. For example, PDFs defining the atmospheric dispersion factors may be derived by using computer algorithms based on hourly wind speed and temperature data at the nuclear power plant site.

The modeled PDFs and CDFs can be compared to collected experimental data corresponding to the respective AST input parameters for validation (and/or future experimental data and evolve accordingly). In this way, the PDFs and CDFs may be empirically developed for each AST input parameter input into a radiation dosage calculation model, such as a RADionuclide Transport, Removal, and Dose (RADTRAD) model. A particular AST input parameter may have multiple possible PDFs or CDFs associated with it because of inherent uncertainty. A probabilistic model of a particular AST input parameter may have a stochastic nature, but given this uncertainty, an iterative simulation may generate distributions of possible outcome values. In some examples, uncertainty may be present and/or may arise from a lack of clarity regarding what data is to be collected or used for the AST input parameters, natural variability of related processes generating the data, randomness in measuring or sampling the data, and/or the like. For example, aerosol removal rates regarding aerosol settling in main stream lines may be uncertain due to time-dependent changes in aerosol particle size. Additionally, uncertainty may result from significant correlations between different input parameters that may interact in unpredictable ways. Accordingly, techniques such as those involving uncertainty parameters and uncertainty propagation equations, for example, can be used in response to the uncertainty.

The uncertainties in the radiation dose calculation model may be at such a level that a Monte Carlo type simulation is useful to achieve a best estimate of a mean estimated radiation dose resulting from the postulated event and a definition of associated uncertainty. To this end, at step 204, one or more input parameters may be sampled. For example, the one or more input parameters may be sampled by the computing device 601. For example, the sampling of the input parameters may include sampling of the necessary input parameters. The selection of which input parameters may be necessary may be performed statistically to accurately represent the respective input distribution. Determined PDFs that describe the various AST input parameters can be randomly sampled and input to the RADTRAD model in the computing device 601 to calculate an estimated radiation dose result. For example, each AST input parameter may be sampled from one or more possible PDFs and/or CDFs. Different PDFs include, for example: lognormal distributions, uniform distributions, triangular distributions, weibull distributions, Poisson distributions, long tail distributions, and the like. The sampling may be based on a suitable sampling technique, such as simple random sampling (SMS), Latin hypercube sampling (LHS), and/or the like. As another example, a CDF may be sampled for an input value using a random number generator. The sampled parameters also may be input and evaluated via application of a Phenomena Identification and Ranking Table (PIRT) process, for example.

The sampling process is repeated for all necessary input parameters, which are then input to the radiation dosage calculation model to calculate a radiation dose result. The calculation of radiation dose results may be iteratively repeated, for example, by the computing device 601, to determine a set of radiation dose results for evaluation. At step 206, a radiation dose may be calculated. For example, the radiation dose may be calculated by the computing device 601. The radiation dose may be calculated using the Monte Carlo simulation. For example, for each iteration of the Monte Carlo simulation, a radiation dose may be calculated using the respective instances of sampled values from the sampled AST input parameters as inputs to the dose model to output the radiation dose. As shown in FIG. 2, the Monte Carlo simulation may iterate between step 204 and step 206 to generate one or more probability distributions of estimated radiation dose results. A statistical combination of results and uncertainties may be determined. After a statistically sufficient number of iterations, the simulation converges on a best estimate of a mean estimated radiation dose of the postulated release and associated statistical uncertainty. The iterations or set of radiation dose results may be statistically combined to determine a mean value (e.g., the best estimate of radiation dose). A statistical uncertainty related to the mean value may also be determined. For example, a best estimate plus uncertainty result may be calculated based on adding or statistically combining the converged best estimate results with the quantified uncertainty. As another example, a bounding mean dose calculation may be determined using an appropriate one-sided probability and confidence level (e.g, 95%). The best estimate mean dose distribution may reflect that a desired quantile such as the 95th percentile is bounded on one side with 95% confidence (e.g., 95% of the simulations contain the true mean dosage population parameter).

At step 208, the radiation does results may be evaluated. For example, the results may be evaluated by the computing device 601. For example, the results may comprise the best estimate plus uncertainty result. This best estimate plus uncertainty result may be evaluated to determine whether the dose consequences are within safety limits, such as internal safety limits or those outlined by 10 C.F.R. § 50.67. Sensitivity analysis may be performed to statistically define the uncertainty present in the dose calculation model. For example, the sensitivity analysis may generate a highest probable value of the best estimate (e.g., the best estimate added to associated statistical uncertainty) and a lowest probable value of the best estimate (e.g., the best estimate subtracted by associated statistical uncertainty), which may be considered upper and lower tolerance limits. The sensitivity analysis may also be applied to individual input parameters to define their respective associated statistical uncertainty via respective upper and lower tolerance limits, for example. In addition, the simulation may indicate which values each AST input parameter had when a particular estimate radiation dose outcome occurred.

In contrast to a deterministic approach, a best estimate plus uncertainty approach including a reasonably conservative confidence level may enable the use of flexible design requirements for a system. The system may be associated with a source of radioactive material. In this way, the accuracy at which a computing device may determine possible radiation doses during a postulated release of radioactivity may be significantly improved to mitigate and control the consequences of a postulated accidental release event. Furthermore, the design and operation of facilities having nuclear material may also be improved. For example, the best estimate plus uncertainty approach may have a better “margin” (e.g. smaller margin of error) by resulting in a lower dose estimate than that yielded by the conservative deterministic approach. The best estimate plus uncertainty approach to radiation dose calculation can be applied to nuclear power plant accident dose consequence analysis. Nuclear power plant design and licensing requires the plant to be designed to withstand specified postulated accidents. The design basis requires analyses to be performed to demonstrate the design of the plant systems meets intended design functions, including limiting the radiation dose consequences to within prescribed regulatory limits. A best estimate plus uncertainty method may improve the design of some plant systems for containing, processing, transporting and controlling a radiological release from the postulated accidents. Sensitivity and tolerance data derived from the best estimate plus uncertainty calculation may be evaluated to demonstrate that adequate conservatism exists under 10 C.F.R. § 50.67.

FIG. 3 shows a graph 300 of an example probability function 306. The probability function 306 may be a probability density function (PDF), which illustrates the probabilistic outcome distribution of an AST input parameter random variable. For example, the PDF 306 may be a PDF that is determined or predicted to model the probabilistic outcomes of a particular AST input parameter. The y-axis 302 of the graph 300 is indicative of probability density. The x-axis 304 of the graph 300 indicates a range of values of the particular AST input parameter according to the probability density. As discussed above, values for the particular AST input parameter may be sampled from the PDF 306, such as at step 204 of FIG. 2. The sampled parameters may be input and evaluated via application of the PIRT process, for example.

The sampling may be based on a suitable sampling technique, such as SMS, LHS and/or the like. The sampling of values from PDFs 300 for each AST input parameter into an estimated dose calculation model may yield results with a lower margin than a deterministic approach. For example, the deterministic approach may result in selection of an input parameter value having a margin of several more standard deviations from the true mean of the corresponding input parameter compared to sampling values in the best estimate plus uncertainty approach. In the deterministic approach, a particular quantile (e.g., 95%) may be used to select a value for an input parameter from the PDF 306. The selected value may represent a worst case scenario, for example. The graph 300 indicates the input parameter value may range from 0 to 2 and that a 1.5 value may be deterministically selected based on the particular quantile, as indicated at the point 308 and dashed line.

In general, one or more PDFs 306 for each AST input parameter may be determined based on the individual characteristics of that AST input parameter. This may include using data to empirically determine the PDFs 306. For example, meteorological data can be gathered to determine the probability distribution of an atmospheric dispersion factor and generate a corresponding PDF 306. Also, data may be obtained from measurement from the actual performance of the system or component. In terms of dose receptors, the PDF may be derived from real physiological measurements, such as breathing rates from a random population of humans or may be based on population density maps and the like. With respect to the estimated dose calculation model, the atmospheric dispersion factor may be directly proportional to dose rate. PDFs for the various AST inputs parameters may also be determined based on sensitivity analysis, tolerance range analysis, simulation and the like.

FIG. 4 shows a graph 400 of an example probability function 406. The probability function 406 may be a cumulative distribution function (CDF), which gives the probability of finding the random variable at a value less than or equal to a particular threshold. For example, the CDF 406 may be a CDF that may be used to determine the probability that a particular AST input parameter has a value within a particular interval. The y-axis 402 of the graph 400 is indicative of the probability of those input parameter values that are less than or equal to a particular threshold value. The x-axis 404 of the graph 400 indicates these threshold values. For example, the probability of the input parameter having a value of 1 is approximately 0.5.

As discussed above, values for the particular AST input parameter may be sampled from the CDF 406, such as at step 204 of FIG. 2. The CDF may be sampled for an input value of a particular AST input parameter using a random number generator. The sampling of values from the CDF 406 for each AST input parameter into an estimated dose calculation model may yield results with a lower margin than a deterministic approach. The deterministic approach may entail selecting a worst case scenario value, such as via selection of the value corresponding to a particular quantile. As shown by the dashed lines in FIG. 4, for example, a 98% quantile could be used such that the fixed value 408 of 1.5 is conservatively selected for a particular AST parameter being input into a dose calculation model for a dose result. The selection of bounding fixed values in this manner may result in compounding effects of conservatism, as discussed herein.

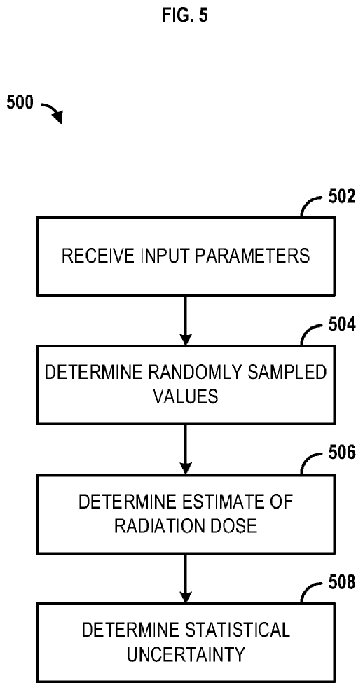

FIG. 5 shows a flowchart illustrating an example method 500 for storage management. The method 500 may be implemented using the environment shown in FIG. 6, for example. For example, the method 500 may be implemented using the computing device 601. At step 502, a plurality of input parameters may be received. For example, the plurality of input parameters may be received by the computing device 601. The input parameters may be associated with a quantity of radioactivity, for example. For example, the quantity of radioactivity may comprise a value indicative of the concentration of radioactivity. As another example, the input parameters may be associated with a transportation of radioactivity. For example, the transportation of radioactivity may be indicative of the rate by which the concentration of radioactivity may increase. The plurality of input parameters may be associated with a source term (e.g. AST) of a postulated (e.g., hypothetical or theoretical) release of radioactivity. For example, a postulated event may involve a postulated release of radiation arising from a postulated LOCA. For example, the plurality of input parameters may comprise one or more of a radionuclide source term parameter, a radionuclide inventory parameter, a radionuclide aerosol removal parameter, a filter removal parameter, a system flow rate parameter, a leak rate parameter, an atmospheric dispersion parameter, a breathing rate parameter, release fraction and timing parameter, fission product removal method parameter, filter efficiency parameter, ventilation flow rate parameter, leak rate parameter, nuclear reactor (e.g., boiling water reactor) building drawdown time parameter, or control room unfiltered in-leakage parameter. A specific type of input parameter of the plurality of input parameters may be identified by the computing device 601, for example. As another example, the computing device 601 may identify the specific type of input parameter of the plurality of input parameters in the instance wherein a plurality of many different types of input parameters of the plurality of input parameters are received. A processor (e.g., a processor 603) of the computing device 601 may process the plurality of input parameters so that the speed and accuracy by which the input parameters are processed are improved upon.

At step 504, sample values may be determined. For example, the sample values may be determined by the computing device 601. For example, the sample values may be determined by a random sampling process and may result in a plurality of randomly sampled values of the plurality of input parameters. For example, the determination of the plurality of randomly sampled values may comprise sampling from one or more of probability distribution functions and/or one or more cumulative distribution functions. As another example, the determination of the plurality of randomly sampled values may comprise performance of a Monte Carlo simulation (e.g., by the computing device 601). It is understood that the Monte Carlo simulation is a mathematical technique that may be used to estimate the possible outcomes of an uncertain event. For example, the number of possible outcomes may be an infinite number associated with the uncertain event. The random sampling process may address and improve upon the compounding effects of excessive conservation in estimated radiation dose calculations as described herein.

At step 506, an estimate of a radiation dose may be determined. For example, the estimate of the radiation does may be determined by the computing device 601. The estimate of the radiation dose may be associated with a radiation release such as the postulated release of radiation arising from the postulated LOCA. For example, the determination of the estimate of the radiation dose may comprise iterative determination of the plurality of randomly sampled values and a plurality of dose values, such as via iterations of the Monte Carlo simulation. The Monte Carlo simulation may involve determining a statistical combination of the plurality of dose values to determine a mean value (e.g., the determined estimate of the radiation dose from the postulated release). In other words, the plurality of radiation dose values may be combined statistically to generate a mean radiation dose result to reflect a realistic estimate with an associated calculated statistical uncertainty (e.g., determining the statistical uncertainty from statistically simulating the dose consequences of damage to a nuclear reactor core) to demonstrate compliance with regulatory or internal limits.

At step 508, a statistical uncertainty may be determined. For example, the statistical uncertainty may be determined by the computing device 601. For example, the statistical uncertainty may be associated with the estimate of the radiation dose. For example, the computing device 601 may compare the estimate of the radiation dose and statistical uncertainty to a threshold. The results of the aforementioned determination may comprise the estimate (e.g., the best estimate) plus the uncertainty result, for example. The estimate of the radiation dose and statistical uncertainty may be a true best estimate dose consequence plus uncertainty. As a further example, a bounding dose may be determined using a desired one-sided probability and confidence level, such as 95%. The best estimate plus uncertainty of the unknown true population parameter (e.g., mean radiation dose) of the radiation dose calculation may improve the accuracy of radiation dose consequences for the postulated release in comparison to a deterministic approach. The best estimate plus statistical uncertainty result may provide a reasonably conservative result for demonstrating compliance with internal limits, regulatory limits, and/or the prescribed limits of 10 C.F.R. § 50.67, for example. In this way, the accuracy at which a computing device may determine the radiation dose calculation may be significantly improved, thereby improving mitigation and control of the radiation consequences of the postulated event.

In an aspect, the methods, systems, and apparatuses may be implemented on or relative to a computer 601 as illustrated in FIG. 6 and described below. Similarly, the methods and systems disclosed may utilize one or more computers to perform one or more functions in one or more locations. FIG. 6 shows a block diagram illustrating an exemplary operating environment 600 for performing the disclosed methods. This exemplary operating environment 600 is only an example of an operating environment and is not intended to suggest any limitation as to the scope of use or functionality of operating environment architecture. Neither should the operating environment 600 be interpreted as having any dependency or requirement relating to any one or combination of components illustrated in the exemplary operating environment 600.

The present methods and systems may be operational with numerous other general purpose or special purpose computing system environments or configurations. Examples of well-known computing systems, environments, and/or configurations that may be suitable for use with the systems and methods comprise, but are not limited to, personal computers, server computers, laptop devices, and multiprocessor systems. Additional examples comprise set top boxes, programmable consumer electronics, network PCs, minicomputers, mainframe computers, distributed computing environments that comprise any of the above systems or devices, and the like.

The processing of the disclosed methods and systems may be performed by software components. The disclosed systems and methods may be described in the general context of computer-executable or processor-executable instructions, such as program modules, being executed by one or more computers or other devices. Generally, program modules comprise computer code, routines, programs, objects, components, data structures, and/or the like that perform particular tasks or implement particular abstract data types. The disclosed methods may also be practiced in grid-based and distributed computing environments where tasks are performed by remote processing devices that are linked through a communications network. In a distributed computing environment, program modules may be located in local and/or remote computer storage media including memory storage devices.

Further, one skilled in the art will appreciate that the systems and methods disclosed herein may be implemented via a general-purpose computing device in the form of a computer 601. The computer 601 may comprise one or more components, such as one or more processors 603, a system memory 612, and a bus 613 that couples various components of the computer 601 including the one or more processors 603 to the system memory 612. In the case of multiple processors 603, the system may utilize parallel computing.

The bus 613 may comprise one or more of several possible types of bus structures, such as a memory bus, memory controller, a peripheral bus, an accelerated graphics port, and a processor or local bus using any of a variety of bus architectures. By way of example, such architectures may comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus 613, and all buses specified in this description may also be implemented over a wired or wireless network connection and one or more of the components of the computer 601, such as the one or more processors 603, a mass storage device 604, an operating system 605, dose analysis software 606, radiation release data 607, a network adapter 608, system memory 612, an Input/Output Interface 610, a display adapter 609, a display device 611, and a human machine interface 602, may be contained within one or more remote computing devices 614a,b,c at physically separate locations, connected through buses of this form, in effect implementing a fully distributed system.

The computer 601 typically comprises a variety of computer readable media. Exemplary readable media may be any available media that is accessible by the computer 601 and comprises, for example and not meant to be limiting, both volatile and non-volatile media, removable and non-removable media. The system memory 612 may comprise computer readable media in the form of volatile memory, such as random access memory (RAM), and/or non-volatile memory, such as read only memory (ROM). The system memory 612 typically may comprise data such as radiation release data 607 and/or program modules such as operating system 605 and dose analysis software 606 that are accessible to and/or are operated on by the one or more processors 603.

In another aspect, the computer 601 may also comprise other removable/non-removable, volatile/non-volatile computer storage media. The mass storage device 604 may provide non-volatile storage of computer code, computer readable instructions, data structures, program modules, and other data for the computer 601. For example, a mass storage device 604 may be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules may be stored on the mass storage device 604, including by way of example, an operating system 605 and dose analysis software 606. One or more of the operating system 605 and dose analysis software 606 (or some combination thereof) may comprise elements of the programming and the dose analysis software 606. Radiation release data 607 may also be stored on the mass storage device 604. Radiation release data 607 may be stored in any of one or more databases known in the art. Examples of such databases comprise, DB2®, Microsoft® Access, Microsoft® SQL Server, Oracle®, mySQL, PostgreSQL, and the like. The databases may be centralized or distributed across multiple locations within the network 1515.

In another aspect, the user may enter commands and information into the computer 601 via an input device (not shown). Examples of such input devices comprise, but are not limited to, a keyboard, pointing device (e.g., a computer mouse, remote control), a microphone, a joystick, a scanner, tactile input devices such as gloves, and other body coverings, motion sensor, and the like These and other input devices may be connected to the one or more processors 603 via a human machine interface 602 that is coupled to the bus 613, but may be connected by other interface and bus structures, such as a parallel port, game port, an IEEE 1394 Port (also known as a Firewire port), a serial port, network adapter 608, and/or a universal serial bus (USB).

In yet another aspect, a display device 611 may also be connected to the bus 613 via an interface, such as a display adapter 609. It is contemplated that the computer 601 may have more than one display adapter 609 and the computer 601 may have more than one display device 611. For example, a display device 611 may be a monitor, an LCD (Liquid Crystal Display), light emitting diode (LED) display, television, smart lens, smart glass, and/or a projector. In addition to the display device 611, other output peripheral devices may comprise components such as speakers (not shown) and a printer (not shown) which may be connected to the computer 601 via Input/Output Interface 610. Any step and/or result of the methods may be output in any form to an output device. Such output may be any form of visual representation, including, but not limited to, textual, graphical, animation, audio, tactile, and the like. The display 611 and computer 601 may be part of one device, or separate devices.

The computer 601 may operate in a networked environment using logical connections to one or more remote computing devices 614a,b,c. By way of example, a remote computing device 614a,b,c may be a personal computer, computing station (e.g., workstation), portable computer (e.g., laptop, mobile phone, tablet device), smart device (e.g., smartphone, smart watch, activity tracker, smart apparel, smart accessory), security and/or monitoring device, a server, a router, a network computer, a peer device, edge device or other common network node, and so on. Logical connections between the computer 601 and a remote computing device 614a,b,c may be made via a network 1515, such as a local area network (LAN) and/or a general wide area network (WAN). Such network connections may be through a network adapter 608. A network adapter 608 may be implemented in both wired and wireless environments. Such networking environments are conventional and commonplace in dwellings, offices, enterprise-wide computer networks, intranets, and the Internet.

For purposes of illustration, application programs and other executable program components such as the operating system 605 are illustrated herein as discrete blocks, although it is recognized that such programs and components may reside at various times in different storage components of the computing device 601, and are executed by the one or more processors 603 of the computer 601. An implementation of dose analysis software 606 may be stored on or transmitted across some form of computer readable media. Any of the disclosed methods may be performed by computer readable instructions embodied on computer readable media. Computer readable media may be any available media that may be accessed by a computer. By way of example and not meant to be limiting, computer readable media may comprise “computer storage media” and “communications media.” “Computer storage media” may comprise volatile and non-volatile, removable and non-removable media implemented in any methods or technology for storage of information such as computer readable instructions, data structures, program modules, or other data. Exemplary computer storage media may comprise RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by a computer.

While the methods and systems have been described in connection with specific examples, it is not intended that the scope be limited to the particular embodiments set forth, as the embodiments herein are intended in all respects to be illustrative rather than restrictive. Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow: plain meaning derived from grammatical organization or punctuation: the number or type of embodiments described in the specification.

It will be apparent to those skilled in the art that various modifications and variations may be made without departing from the scope or spirit. Other embodiments will be apparent to those skilled in the art from consideration of the specification and practice described herein. It is intended that the specification and examples be considered as exemplary only, with a true scope and spirit being indicated by the following claims.

What is claimed is:

1. A method comprising:
receiving a plurality of input parameters associated with a quantity and transportation of radioactivity;
determining, via a random sampling process, a plurality of randomly sampled values of the plurality of input parameters;
determining an estimate of a radiation dose, wherein the estimate of the radiation dose is associated with a radiation release resulting from a postulated release of radioactivity; and
determining a statistical uncertainty associated with the estimate of the radiation dose.

2. The method of claim 1, wherein the plurality of input parameters comprise one or more of a radionuclide source term parameter, radionuclide inventory parameter, a radionuclide aerosol removal parameter, a filter removal parameter, a system flow rate parameter, a leak rate parameter, an atmospheric dispersion parameter, or a breathing rate parameter.

3. The method of claim 1, wherein determining the plurality of randomly sampled values of the plurality of input parameters is based on one or more of a probability distribution function or a cumulative distribution function.

4. The method of claim 1, wherein determining the plurality of randomly sampled values of the plurality of input parameters comprises performance of a Monte Carlo simulation.

5. The method of claim 1, further comprising comparing the estimate of the radiation dose and the statistical uncertainty to a threshold.

6. The method of claim 1, wherein determining the estimate of the radiation dose comprises an iterative determination of the plurality of randomly sampled values and a plurality of radiation dose values.

7. The method of claim 6, further comprising determining a statistical combination of the plurality of radiation dose values.

8. The method of claim 1, wherein the postulated release of radioactivity corresponds to damage to one or more of a nuclear reactor core or a fuel rod.

9. An apparatus, comprising:
one or more processors; and
a memory storing processor-executable instructions that, when executed by the one or more processors, cause the apparatus to:
receive a plurality of input parameters associated with a quantity and transportation of radioactivity;
determine, via a random sampling process, a plurality of randomly sampled values of the plurality of input parameters;
determine an estimate of a radiation dose, wherein the estimate of the radiation dose is associated with a radiation release resulting from the postulated release of radioactivity; and
determine a statistical uncertainty associated with the estimate of the radiation dose.

10. The apparatus of claim 9, wherein the plurality of input parameters comprises one or more of a radionuclide source term parameter, a radionuclide inventory parameter, a radionuclide aerosol removal parameter, a filter removal parameter, a system flow rate parameter, a leak rate parameter, an atmospheric dispersion parameter, or a breathing rate parameter.

11. The apparatus of claim 9, wherein the processor-executable instructions that, when executed by the one or more processors, cause the apparatus to determine the plurality of randomly sampled values of the plurality of input parameters, cause the apparatus to determine the plurality of randomly sampled values of the plurality of input parameters based on one or more of a probability distribution function, a cumulative distribution function, or a Monte Carlo simulation.

12. The apparatus of claim 9, wherein the processor-executable instructions, when executed by the one or more processors, further cause the apparatus to compare the estimate of the radiation dose and the statistical uncertainty to a threshold.

13. The apparatus of claim 9, wherein the processor-executable instructions that, when executed by the one or more processors, cause the apparatus to determine the estimate of the radiation dose, cause the apparatus to:
conduct an iterative determination of the plurality of randomly sampled values and a plurality of radiation dose values; and
determine a statistical combination of the randomly sampled values and the plurality of radiation dose values.

14. The apparatus of claim 9, wherein the postulated release of radioactivity corresponds to a time interval associated with a determination of damage to one or more of a nuclear reactor core or a fuel rod.

15. A non-transitory computer-readable medium storing processor-executable instructions that, when executed by at least one processor, cause the at least one processor to:
receive a plurality of input parameters associated with a source term of a postulated release of radioactivity;
determine, via a random sampling process, a plurality of randomly sampled values of the plurality of input parameters;
determine an estimate of a radiation dose, wherein the estimate of the radiation dose is associated with a radiation release resulting from the postulated release of radioactivity; and
determine a statistical uncertainty associated with the estimate of the radiation dose.

16. The non-transitory computer-readable medium of claim 15, wherein the plurality of input parameters comprises one or more of a radionuclide source term parameter, a radionuclide inventory parameter, a radionuclide aerosol removal parameter, a filter removal parameter, a system flow rate parameter, a leak rate parameter, an atmospheric dispersion parameter, or a breathing rate parameter.

17. The non-transitory computer-readable medium of claim 15, wherein the processor-executable instructions that, when executed by the at least one processor, cause the at least one processor to determine the plurality of randomly sampled values of the plurality of input parameters, cause the at least one processor to determine the plurality of randomly sampled values of the plurality of input parameters based on one or more of a probability distribution function, a cumulative distribution function, or a Monte Carlo simulation.

18. The non-transitory computer-readable medium of claim 15, wherein the processor-executable instructions, when executed by the at least one processor, further cause the at least one processor to compare the estimate of the radiation dose and the statistical uncertainty to a threshold.

19. The non-transitory computer-readable medium of claim 15, wherein the processor-executable instructions that, when executed by the at least one processor, cause the at least one processor to determine the estimate of the radiation dose, cause the at least one processor to:
cause an iterative determination of the plurality of randomly sampled values and a plurality of radiation dose values; and
determine a statistical combination of the randomly sampled values and the plurality of radiation dose values.

20. The non-transitory computer-readable medium of claim 15, wherein the postulated release of radioactivity corresponds to a time interval associated with a determination of damage to one or more of a nuclear reactor core or a fuel rod.
